(19) United States
(12) Patent Application Publication
(10) Pub. No.: US 2008/0178484 A1
(43) Pub. Date: Jul. 31, 2008

(54) DECK MEASURE

(76) Inventor: WILLIAM COTHER, MILFORD, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/669,592

(22) Filed: Jan. 31, 2007

(51) Int. Cl. G01B 1/00

(52) U.S. Cl. 33/526

(57) ABSTRACT

A deck board space measure, preferably of unitary construction. It has a rocker arm portion with a top surface and a bottom surface with a handle portion extending generally upwards from the top surface and a space measure having a width extending down from the bottom surface, with the width of the space measure defining the space desired between adjacent deck boards.

### FIELD OF THE INVENTION

This invention relates to a tool for use in providing quick, easy uniform measurements for the space between deck boards.

### BACKGROUND OF THE INVENTION

Decks for primary homes and second homes have become increasingly popular in recent years. As such, there is an ever increasing need for skill in building deck surfaces, and in building them quickly and uniformly. Proper deck surfaces have even spacing between the boards of the deck, both for appearance purposes and for proper distribution of deck surface stress. In order to ensure proper spacing between the boards of a deck surface, many carpenters have developed and used their own jigs and/or make-do with other tools, designed for different purposes to measure spacing. The results from such make-do devices are at best uneven. One such result is that the make-do device such as screwdrivers, must be held the same each time or else spacing between the deck boards is uneven. This unevenness is often the result if the device used is, for example, a screw driver or something like that which, if held up non-uniformly, results in uneven spacing. Moreover, sometimes the item used by the carpenter to control the spacing between deck boards when extracted after the board is secured, results in damages to the board, if the fit is snug. This results in splinters and, depending on what is used, can also result in damage to the hand of the carpenter using the tool. It goes without saying that both of these results are undesirable.

As can be seen from the above general description of the problem, there is a need for a tool specifically designed for providing even spacing between boards of a deck board surface when installed.

There is a further need for a specific tool which not only will provide constant and uniform spacing, but will do so in a manner that will not damage the deck board surface or the hand of the carpenter using the tool.

There is an even further need for a tool which is quick and easy to use, provides uniformity without great effort and which does not depend upon constant attention by the carpenter in order to get uniformity of spacing.

A primary objective of the present invention is to fulfill the above needs. Namely, to provide a quick, easy to use and reliable deck space measure. Also, to provide such a quick, easy and reliable deck space measure which can be used with a minimum of risk of damage to the deck board surface or to the hand of the user.

The method of achieving the above primary objectives as well as others will become apparent from the detailed description of the invention which follows hereinafter.

### BRIEF SUMMARY OF THE INVENTION

A deck board space measure, preferably of unitary construction. It has a rocker arm portion with a top surface and a bottom surface with a handle portion extending generally upwards from the top surface and a space measure having a width extending down from the bottom surface, with the width of the space measure defining the space desired between adjacent deck boards.

### BRIEF DESCRIPTION OF THE DRAWINGS

FIG. 1 is a perspective view of the deck measure of the present invention.

FIG. 2 is a side view along line 2-2 of FIG. 1.

FIG. 3 is a side view along line 3-3 of FIG. 2.

FIG. 4 shows a deck surface with one board affixed and the next board ready for securement with the deck tool inserted.

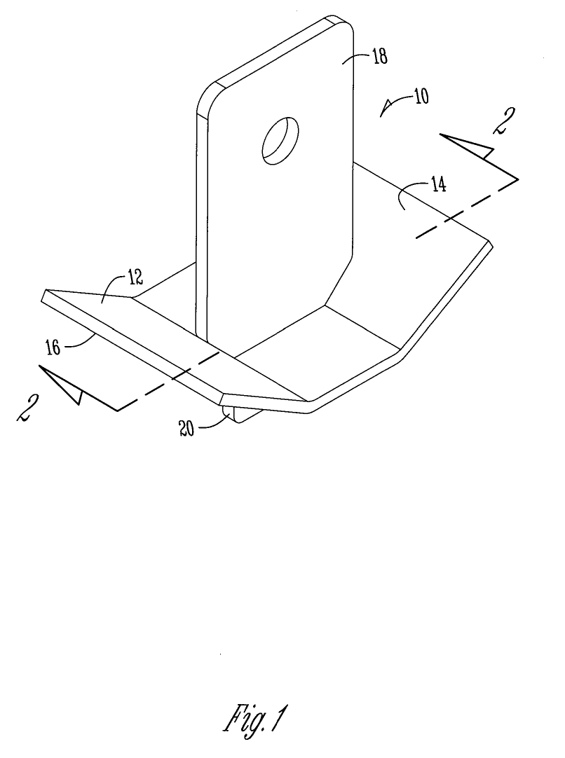

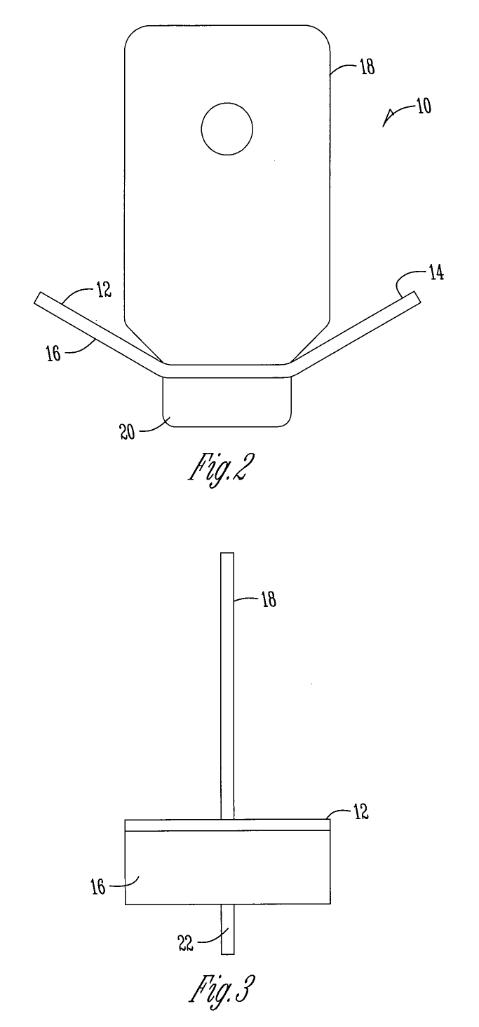

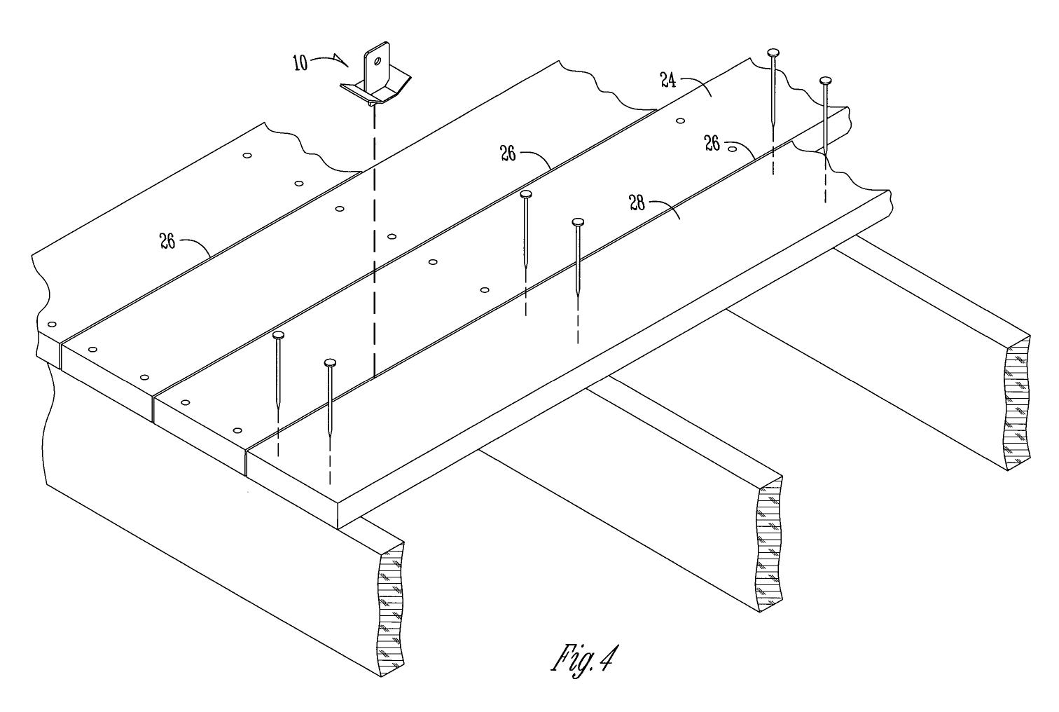

### DETAILED DESCRIPTION OF THE PREFERRED EMBODIMENT

Deck board space measure 10 is comprised of a rocker arm portion 12 having a top surface 14 and a bottom surface 16. Extending generally upwards from the rocker arm portion 12 is a handle 18 of sufficient size and dimension to be conveniently grasped by a carpenter's hand. Extending downwardly from bottom surface 16 of the rocker arm 12 is space measure 20. Space measure 20 has a width 22 defined by the width of the desired space between deck boards. This can vary from deck to deck but is generally within the range of from ¼ inch to ⅜ of an inch. The length of space measure 22, i.e., how far it extends below the lower surface 16 of rocker arm 12 also can vary but generally an inch is satisfactory to provide uniform measurements and easy extraction.

Preferably the deck board measure is a single piece solid unit. It can be made from wood, hard polymeric plastic material, steel or even polished rock mineral. Preferred is welded steel for durability and ease of manufacture. The unit is then covered with a smooth coating material, preferably a ceramic coating or a latex coating. Either one will give a smooth soft feel to the unit so that it will not cause damage to the user's hand or to the deck boards.

FIG. 4 illustrates the unit being used. As illustrated, there is a fixed deck board 24 and a space between it and the next deck board 28 defined at 26. Device 10 has its deck measure 20 inserted into space 26 and board 28 is then tapped lightly to define the width of space 26 which will be equal to the width of spacer 22. Board 28 is then secured by nails, screw nails, etc. The handle portion 18 is then grabbed, rocked back and forth, and pulled out to remove the measure from the space. The process is repeated over and over until the deck surface is completed.

If a board 24 is warped, two devices 10 may be used to pull the warp straight, as herein described. One device is inverted and inserted into space 26, handle portion down. Another is inserted into the next space, handle portion up and a quick grip clamp is locked onto the rocker arm 12 and the outside of last board and then clamped tight to squeeze the warp out of the board, at which point fastener nails are then driven into affix the boards 24 to the deck. Both devices 10 are then removed.

It goes without saying that certain changes in the construction features of the device may be made without departing from the spirit and scope of the invention. And, it is fully intended that such changes are within the scope of the claimed invention, it being the inventor's desire to claim the deck measure as broadly as possible with the only limitation being the scope and content of the prior art.

What is claimed is:

1. A deck board space measure, comprising:
a rocker arm portion having a top surface and a bottom surface;
a handle portion extending generally upward from said top surface; and
a space having a width, extending downward from said bottom surface, width of said space measure defining the space desired between deck boards.

2. The deck board measure of claim 1 wherein the measure is a single piece solid unit.

3. The deck board measure of claim 2 wherein the measure is made from a material selected from the group consisting of wood, polymeric plastic, steel and polished stock mineral.

4. The deck board measure of claim 3 wherein the material is steel.

5. The deck board measure of claim 4 wherein the steel is covered with a smooth coating material.

6. The deck board measure of claim 5 wherein the coating material is a ceramic coating.

7. A method of providing uniform spacing between deck boards, comprising:
inserting a deck board space measure having a rocker arm portion having a top surface and a bottom surface;
a handle portion extending generally upward from said top surface; and
a space having a width, extending downward from said bottom surface, width of said space measure defining the space desired between deck boards between a secured deck plant and the next one to be secured;
securing the plant;
grabbing the handle portion and rocking it back and forth; and
removing the deck measure from the space.

8. The method of claim 7 which is repeated until the dark plank surface is completed.
